(19) United States
(12) Patent Application Publication
(10) Pub. No.: US 2017/0064486 A1
(43) Pub. Date: Mar. 2, 2017

(54) Application Software for Movable Barrier Operation

(71) Applicant: The Chamberlain Group, Inc., Elmhurst, IL (US)

(72) Inventor: James J. Fitzgibbon, Batavia, IL (US)

(21) Appl. No.: 14/833,963

(22) Filed: Aug. 24, 2015

(51) Int. Cl. H04W 4/00; H04W 4/02; H04B 17/318; H04M 1/725; H04L 29/08

(52) U.S. Cl. CPC H04W 4/003; H04M 1/72527; H04L 67/26; H04B 17/318; H04W 4/023; H04M 1/72583

(57) ABSTRACT

A method, apparatus, and application software (“app”) stored on a computer readable medium is provided that utilizes a signal from a movable barrier operator or other device to cause an automatic action via an app operating on a mobile communication device receiving the signal. The app can further send an authorized command signal to operate the movable barrier operator to open and close a movable barrier.

### FIELD

The present application relates to remote control of access control devices, and more particularly automatically performing an action via reception of a signal.

### BACKGROUND

Movable barrier operators are configured to receive communications from a variety of transmission devices, such as dedicated or learning transmitters. Moreover, with the development of mobile communication devices, such as smart phones and tablets, these devices have also been programmed to send authorized control signals to the movable barrier operator. Rather than provide the easy use of a dedicated button, mobile communication devices have other functionalities and programs. Accordingly, to transmit a control signal, a user can be required to unlock the device, find and select an appropriate icon, select a desired movable barrier operator, and select a button to send the signal. These steps can be time consuming. Moreover, if the mobile communication device is being used inside a vehicle, these steps may distract a driver of the vehicle.

### SUMMARY

Generally speaking, and pursuant to these various embodiments, a method, apparatus, and mobile device application software stored on a computer-readable medium are described that cause an automatic action on a mobile communication device in response to the reception of a signal from a movable barrier operator or other transmission device disposed adjacent to the movable barrier operator. The automatic action is an action performed by the application software installed and operating on the mobile communication device. The application software can compare an identifier or other information of the received signal to prestored signal information to determine whether to perform the action. With the application software automatically operating, the user need not use the time and attention necessary to perform many operations on a mobile communication device.

### BRIEF DESCRIPTION OF THE DRAWINGS

The above needs are at least partially met through provision of the method, apparatus, and application software described in the following detailed description, particularly, when studied in conjunction with the drawings wherein:

FIG. 1 is a schematic diagram a premises with a movable barrier operator controlling movement of a movable barrier and a mobile communication device in communication with the movable barrier operator and configured to receive a signal therefrom;

FIG. 2 is a schematic diagram of a mobile communication device;

FIG. 3 is a diagram of a mobile communication device showing a display without an active, forward application, a display with an active, forward application, a display with a push notification, and a display with a push notification and a software switch;

FIG. 4 is a diagram of an inside of a vehicle showing a dashboard, windshield, and mirror with optional display and antenna configurations; and

FIG. 5 is a flow chart as configured in accordance with various embodiments of the description.

Skilled artisans will appreciate the elements and the figures are illustrated for simplicity and clarity and have not necessarily been drawn to scale. For example, the dimensions and/or relative positioning of some of the elements in the figures may be exaggerated relative to other elements to help improve understanding of various embodiments. Also, common but well understood elements that are useful or necessary in a commercially feasible embodiment are often not depicted to facilitate a less obstructive view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions and a person skilled in the technical field as set forth above, except where different specific meanings have otherwise been set forth herein.

### DETAILED DESCRIPTION

A method, apparatus, and application software (“app”) stored on a computer readable medium is provided that utilizes a signal from a movable barrier operator or other device to cause an automatic action via an app operating on a mobile communication device receiving the signal. The automatic action can include bringing the app to the front on a display of the mobile communication device, activating and displaying the app on the mobile communication device, and/or causing the app to send an activation signal to the movable barrier operator.

Bringing the app to the front on the display of the mobile communication device can include causing the app to appear on the display from operating in the background, opening the app and causing it to display, and/or causing a push notification of the app to display on the display, such as a badge, banner, or the like. Moreover, the app can present a button or switch to a user, the selection of which will cause the app to perform an action. The action can include sending a command signal to the movable barrier operator, stopping the app from sending a command signal, or the like.

The app can further take signal strength of the signal into account when deciding when or what action to perform. For example, the app can determine that the mobile communication device is approaching the movable barrier operator via the signal strength increasing with movement or determine that the mobile communication device is going away from the movable barrier operator via the signal strength decreasing with movement. The app can bring itself to the front of the mobile communication device display and/or transmit an opening command signal to the movable barrier operator in response to approaching the movable barrier operator and move the app to the background of the mobile communication device and/or transmitting a closing command signal to the movable barrier operator in response to going away from the movable barrier operator. This is particularly advantageous where the mobile communication device is incorporated into a vehicle with the app running on a computing device of the vehicle or a mobile phone operatively connected to a vehicle computing device, e.g., the app running on the mobile phone and mirrored or exported to display and/or operate on the vehicle computing device and associated display. By another approach, instead of automatically sending the opening or closing command signals, the app can present a button or switch to a user configured so that a user selection of the switch causes the app to transmit the opening or closing command signal.

The app can also present pre-activation warnings to a user of the mobile communication device. For example, the app can present a warning to a user that the app will cause the opening or closing command signal to be transmitted in a predetermined amount of time, such as 5 seconds, 10 seconds, or the like. Pursuant to this, the app can additionally present a cancel action button or switch for the user to select if the user does not want the app to transmit the opening or closing command signal.

By another approach, the app can also provide a user the functionality to restrict automatic operation of the app. For example, the user can input time information according to which the app is permitted to send command signals. This can include a preset amount of time from a current time, e.g., if the mobile communication device receives the signal from the movable barrier device within the next 10 minutes. The user can also or alternatively include setting time spans during which the app can operate, e.g., 6 am-10 am and 4 pm-8 pm.

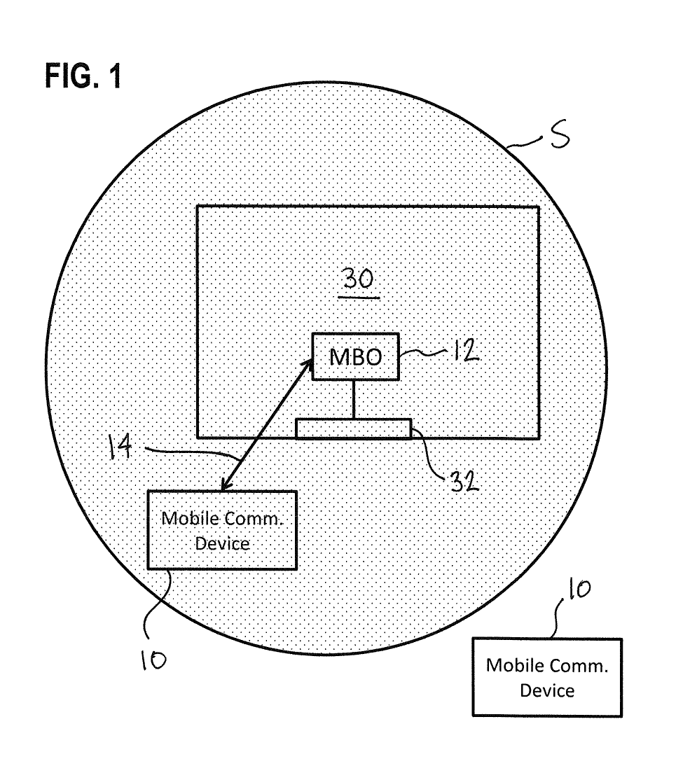

Details of the interacting components and structure of the system disclosed herein are shown in FIG. 1. As illustrated, a mobile communication device 10 and a movable barrier operator or other access control device 12 are capable of communication with one another through one or more communication networks 14. Suitable communication networks 14 can include, without limitation, the Internet, a cellular network, Bluetooth, or other communication medium, or a combination thereof. The mobile communication device 10 can be any suitable communication device, such as a mobile phone, tablet, computing device, E-reader, communication enabled vehicle, or the like.

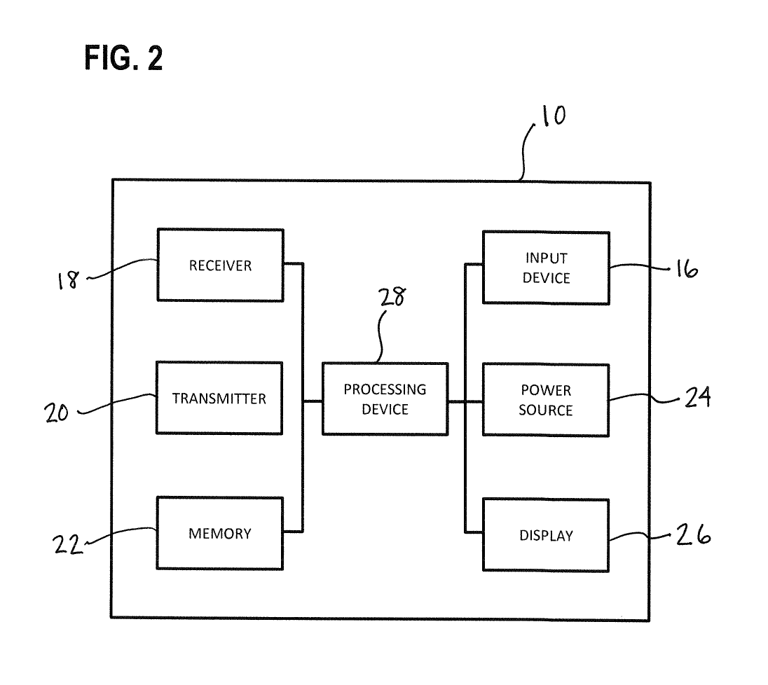

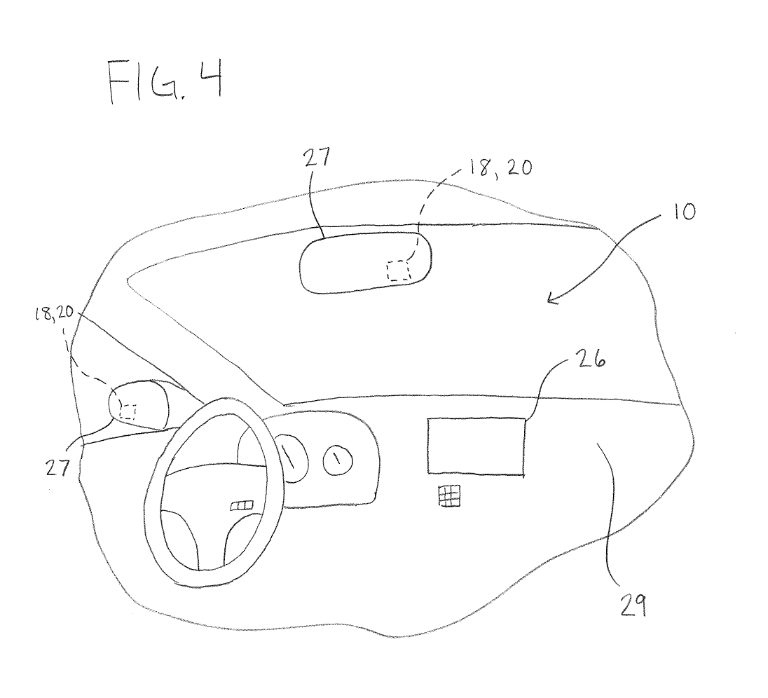

As shown in FIG. 2, the mobile communication device 10 can include a user input 16, such as a touch screen, keypad, switch device, voice command software, or the like, a receiver 18, a transmitter 20, which can both be incorporated within a transceiver, a memory 22, a power source 24, which can be replaceable or rechargeable as desired, a display 26, and a processing device 28 controlling the operation thereof. As commonly understood, the components are connected by electrical pathways, such as wires, traces, circuit boards, and the like. As shown in FIG. 4, the mobile communication device 10 can alternatively have a distributed configuration, such as in a vehicle setting. In such a configuration, the receiver and transmitter 18, 20 can be incorporated into a mirror 27, such as a rear view or side view mirror, dashboard 29, body, and/or other areas of the vehicle. The display 26 can be incorporated into the dashboard 29 to provide easy visual access to a user.

FIG. 1 shows an example diagram of a premises 30 setting. The movable barrier operator 12 is disposed or mounted within or adjacent to the premises 30 to control operation of a movable barrier 32, such as a garage door, gate, locked door, or the like. As such, the movable barrier operator 12 can operate in response to reception of an opening command signal to move the movable barrier to an open position to allow access to the premises therethrough and can operate in response to reception of a closing command signal to move the movable barrier to a closed position to deny access to the premises. While opening and closing command signals are being used herein for the sake of explanation, it will be understood that opening and closing command signals transmitted to the movable barrier operator need not be identifiably distinct.

As shown, the movable barrier operator 12 can transmit a wireless signal S (via WiFi, Bluetooth, or other suitable protocol) therefrom, which can be periodically or continuously broadcast, to a predetermined range therearound. Of course, the signal can be transmitted from a device separate from or associated with the movable barrier operator, such as a home network device, third party device, retro fit device, or the like. As such, it will be understood herein that when the movable barrier operator 12 is described as transmitting the signal, this also includes a separate device transmitting the signal.

Accordingly, as the mobile communication device 10 approaches the movable barrier operator 12, the mobile communication device 10 eventually receives the signal and the received signal strength will increase as the mobile communication device 10 gets closer to the movable barrier operator 12. Moreover, as the mobile communication device 10 moves away from the movable barrier operator 12, the received signal strength slowly decreases until the mobile communication device 10 loses the signal.

Turning now to details of the app, the app can be available for purchase and/or download from any website, online store, or vendor over any suitable communication network 14. Alternatively, a user can download the application onto a personal computer and transfer the app to a suitable device. In this instance, the user downloads and installs the app on the mobile communication device 10. When operation is desired, the user runs the app on the mobile communication device 10 by a suitable selection through the user input 16.

The app utilizes access rights data that includes identification information of the movable barrier operator 12 and corresponding authorization information for access rights to the movable barrier operator 12. In other words, the access rights data includes credentials required by the movable barrier operator 12, a conditional requirement for allowing the credentials, and the identification information of the movable barrier operator 12. If desired, the app can cause the access rights data to be stored in the memory 22 of the mobile communication device 10. This information can be manually entered by the user through the user input 16 of the mobile communication device 10, by download from the movable barrier operator 12, by retrieving or receiving the access rights data from a network device, or the app can have a learn mode similar to a learning transmitter known in the art so that the mobile communication device 10 receives and stores the information from a transmission of an authorized transmitter. Thus, the app can provide the user with transmitter functionality to send an authorized control signal to the movable barrier operator 12 with the mobile communication device 10.

As discussed above, the app is configured to be responsive to the reception of the signal to automatically perform an operation. More specifically, in response to receiving the signal S, the app can compare information regarding or contained within the signal S, such as an identifier, including, for example, an SSID of a home network, to prestored signal information to confirm that the app is supposed to operate. The prestored signal information can be stored in the memory 22 of the mobile communication device 10 or stored remotely on a server device or other computing device. The prestored signal information can be entered via any of the methods discussed above with respect to the access rights or via a third party.

After confirming that the signal identifier matches the prestored signal information, the app can determine a next action previously set by the user. For example, the user can set the app to automatically perform one or more of the following: rise to the front of the display of the mobile communication device, send a command signal, present a software switch to transmit a control signal, present a software switch to stop transmission of a time delayed command signal, present a timer count down until a subsequent action is performed, cause the app to operate on a secondary computing device, for example via a relationship, such as Bluetooth pairing, between a mobile phone and a vehicle computing device, appear on a secondary display, e.g., a vehicle display via a relationship with a mobile phone, or the like.

Moreover, many mobile communication devices can be locked when not currently in use, and require the entry of a passcode or a biometric entry, such as a fingerprint scan, to unlock the mobile communication device. In such a case, the app can bypass the lock screen to perform the various actions above in response to receiving the signal or can present the various display and/or switch options in front of the lock screen. Additionally, if desired, selecting the display and/or switch can direct the user to a passcode and/or biometric entry screen, and the app can be configured to display after correct entry of the passcode or biometric entry.

The user can further place temporal restrictions on the performance of the action. Accordingly, after or before determining a next action, the app can determine whether restrictions are in place and currently applicable.

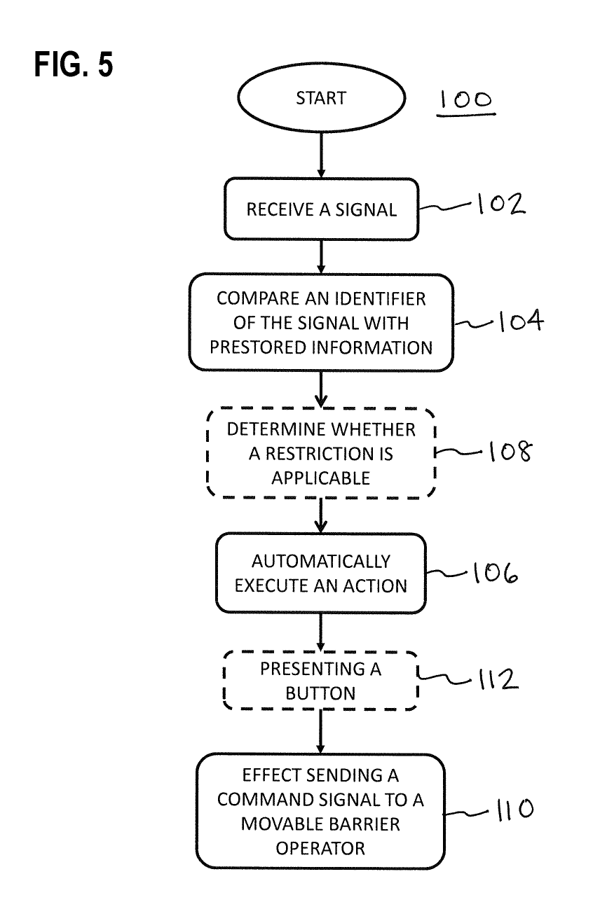

In one example method as shown in FIG. 5, the user can approach the premises 30 in a vehicle. By a first approach, the mobile communication device 10 can be a mobile phone carried on the user's person operating or riding in the vehicle. By another approach, the mobile communication device 10 can be incorporated into the vehicle. For example, the vehicle can include an antenna 18, 20, disposed in a dashboard 29, mirror 27, or the like, and a corresponding computing device configured to monitor for and receive the signal S via the antenna 18. In this example, the app can be operating on a computing device of the vehicle and operably connected to the antenna 18, 20. By yet another approach, the mobile communication device 10 can be a mobile phone operatively connected, e.g., via a Bluetooth pairing or the like, to a computing device of the vehicle. In a first example, the display coupled to the vehicle computing device can duplicate the display of the app operating on the mobile phone. As such, the user can provide input to the app through the mobile phone, through an input device of the vehicle computing device, or both. In a second example, the mobile phone can export or copy the app to the vehicle computing device to operate independently on the vehicle device.

The vehicle approaches the premises 30 and the mobile communication device 10 receives 102 the signal broadcast from the movable barrier operator 12 or other transmission device. In response to reception of the signal, the app determines 104 whether an identifier of the signal matches the stored signal information in the memory of the mobile communication device 10 or stored remotely for further action by the app. In response to determining that the signal matches that stored in the memory of the mobile communication device 10, the app automatically performs 106 an action. If desired, the app can also determine 108 whether any restrictions are in place and applicable to the current situation prior to automatically performing an action. As set forth above, the user can input time information according to which the app is permitted to send command signals. This can include a preset amount of time from a current time, e.g., if the mobile communication device receives the signal from the movable barrier device within the next 10 minutes. The user can also or alternatively include setting time spans during which the app can operate, e.g., 6 am-10 am and 4 pm-8 pm. This allows a user to restrict the times when the app can automatically operate and can coincide with typical times when the user would desire movement of the movable barrier 32. If there are no applicable restrictions, the app can then effect sending 110 of a command signal to the movable barrier operator 12. If desired, as set forth above, the app can present 112 a button that the selection of which by the user cause the app to effect sending of the command signal.

Moreover, application settings and authorization can be remotely stored and controlled on a server device or other remote platform. This advantageously allows a user to access and restrict operation of the app without physically having the mobile communication device. As such, if a user loses the mobile communication device, the user can remotely access the settings and authorization of the app to stop further action and delete any authorization, credential, or personal information stored on the mobile communication device for the app.

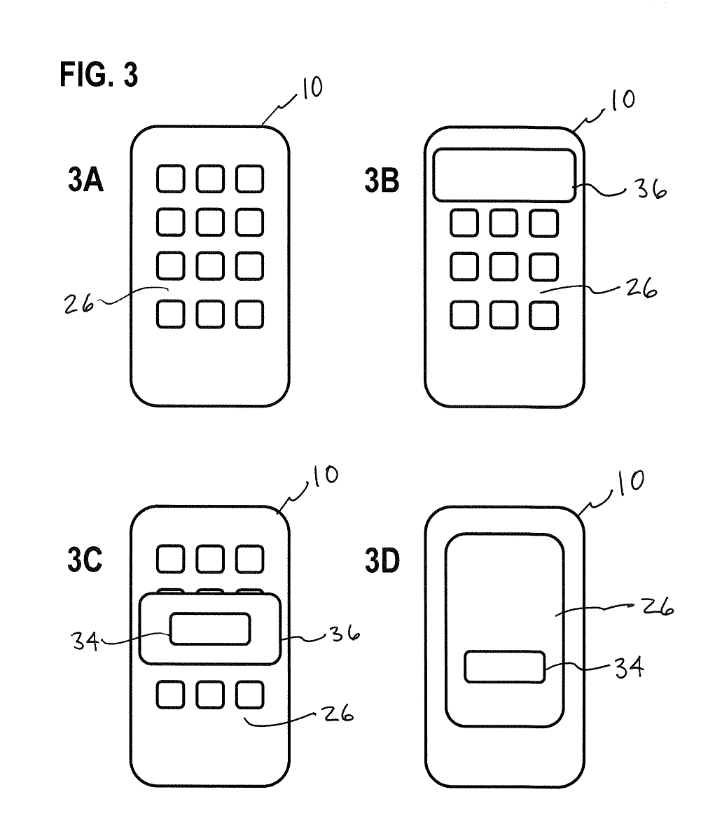

FIG. 3A shows a mobile communication device 10 without an app or push notification displayed, although an app can be operating in a background. In a first approach, shown in FIG. 3B, the app rises to the front of the display of the mobile communication device and informs the user of the approaching premises 30 and movable barrier operator 12. The app can be opened in this instance or raised forward from operating in the background. If desired, the app can present a software switch 34 to send a command signal to the movable barrier operator 12 to move the movable barrier to an open position. If the app takes signal strength into account, the app will determine that the mobile communication device is approaching the movable barrier operator 12 and present the option to send an opening command signal. The app can also present the option to ignore the signal and not perform a further action. Of course, the app can also be configured to automatically send the command signal to the movable barrier operator 12 and the software switch 34 can instead provide the user with an option to stop automatic transmission of the command signal.

After transmission of the command signal, when the user can pull the vehicle into the premises 30, the app can present a further software switch 34 to send a second command signal to the movable barrier operator 12. In this case, selection of the software switch would command the movable barrier operator to move the movable barrier to a closed position. This advantageously allows the user to close the movable barrier after the vehicle is pulled into the premises, allows the user to resecure the premises, and allows the user the close the movable barrier in case the user did not intend or want the app to cause opening of the movable barrier.

By another approach, shown in FIGS. 3C and 3D, the app can present a push notification 36 on the display 26 of the mobile communication device 10. The push notification 36 can take any suitable shape or configuration. As shown in FIG. 3B, the push notification 36 can be used by the app to provide information to the user, including informing the user of a pending command signal transmission, that the movable barrier operator 12 is approaching, that there are applicable restrictions in place, or the like. As shown in FIG. 3C, the push notification 36 can also include a software switch 34 configured as discussed above with respect to FIG. 3B.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A method comprising:
receiving a signal at a mobile communication device;
comparing an identifier of the signal with prestored information with application software operating on the mobile communication device;
automatically executing an action with the application software in response to determining that the identifier of the signal matches the prestored information, wherein the action includes displaying an application window including a user interface button for the application software on a display of the mobile communication device;
effecting sending a command signal to a movable barrier operator with the application software in response to detecting selection of the user interface button.

2. (canceled)

3. The method of claim 1 wherein displaying the application window of the application software on the display of the mobile communication device comprises bringing the application window of the application software forward from operating in a background to the display of the mobile communication device.

4. The method of claim 1 wherein displaying the application window of the application software on the display of the mobile communication device comprises opening the application software and displaying the application window of the application software on the display of the mobile communication device.

5. The method of claim 1 wherein displaying the application window of the application software on the display of the mobile communication device comprises displaying a push notification including the user interface button on the display of the mobile communication device.

6. (canceled)

7. (canceled)

8. The method of claim 1 wherein receiving the signal at the mobile communication device further comprises determining a received signal strength of the received signal.

9. The method of claim 8 further comprising:
determining that the mobile communication device is moving away from the movable barrier operator in response to determining that the received signal strength is decreasing; and
sending a closing command signal to the movable barrier operator with the application software in response to determining that the mobile communication device is moving away from the movable barrier operator.

10. The method of claim 8 further comprising:
determining that the mobile communication device is approaching the movable barrier operator in response to determining that the received signal strength is increasing; and
wherein sending the command signal to a movable barrier operator with the application software comprises sending an opening command signal to the movable barrier operator with the application software in response to determining that the mobile communication device is approaching the movable barrier operator.

11. The method of claim 1 further comprising:
determining whether there are any applicable restrictions with the application software prior to sending the command signal; and
sending the command signal in response to determining that there are no applicable restrictions.

12. A non-transistory computer readable medium having instructions stored thereon that, in response to execution by a mobile communication device, cause the mobile communication device to perform operations comprising:
receiving a signal;
comparing an identifier of the signal with prestored information;
automatically executing an action in response to determining that the identifier of the signal matches the prestored information including displaying an application window including a user interface button for the application software on a display of the mobile communication device;
effecting sending a command signal to a movable barrier operator in response to detecting selection of the user interface button.

13. (canceled)

14. The non-transistory computer readable medium of claim 12 wherein displaying the application window of the application software on the display of the mobile communication device comprises bringing the application window of the application software forward from operating in a background to the display of the mobile communication device.

15. The non-transistory computer readable medium of claim 12 wherein displaying the application window of the application software on the display of the mobile communication device comprises opening the application software and displaying the application window of the application software on the display of the mobile communication device.

16. The non-transistory computer readable medium of claim 12 wherein displaying the application window of the application software on the display of the mobile communication device comprises displaying a push notification including the user interface button on the display of the mobile communication device.

17. (canceled)

18. (canceled)

19. The non-transistory computer readable medium of claim 12 wherein receiving the signal at the mobile communication device further comprises determining a received signal strength of the received signal.

20. The non-transistory computer readable medium of claim 12 further comprising:
determining whether there are any applicable restrictions to sending the command signal; and
sending the command signal in response to determining that there are no applicable restrictions.

21. An apparatus comprising:
a processing device;
a receiver; and
a transmitter;
wherein the processing device is configured to:
receive a signal;
compare an identifier of the signal with prestored information;
automatically execute an action in response to determining that the identifier of the signal matches the prestored information including displaying an application window including a user interface button for the application software on a display of the mobile communication device;
effect sending a command signal to a movable barrier operator in response to detecting selection of the user interface button.

22. (canceled)

23. (canceled)
